(19) United States
(12) Patent Application Publication
(10) Pub. No.: US 2011/0194490 A1
(43) Pub. Date: Aug. 11, 2011

(54) METHOD FOR TCP ACK CONTAINMENT IN UNIDIRECTIONAL FLOWS WITH CROSS LAYER OPTIMIZATION IN WIRELESS NETWORKS

(75) Inventors: Shashidhar R. Gandham, Fremont, CA (US); Amit Shukla, San Jose, CA (US); Ajay Kulkarni, San Jose, CA (US)

(73) Assignee: XG TECHNOLOGY, INC., Sarasota, FL (US)

(21) Appl. No.: 13/021,760

(22) Filed: Feb. 6, 2011

Related U.S. Application Data
(60) Provisional application No. 61/337,649, filed on Feb. 10, 2010.

(51) Int. Cl. H04W 72/00

(52) U.S. Cl. 370/328

(57) ABSTRACT

A method that addresses a cross layer optimization technique for TCP in which the need to send ACK frames across wireless links is contained by using the information from the MAC layer acknowledgements is disclosed. More specifically the method significantly reduces bandwidth consumption and improves the performance of TCP on wireless networks. Furthermore, since the number of transmitted and received packets is reduced at the mobile device, the battery life of the device can be improved significantly. The proposed method can also be applied to downlink and uplink ACK frames with a slight variation between the two.

### CROSS-REFERENCE TO RELATED APPLICATION

The present application claims the benefit of previously filed co-pending Provisional Patent Application Ser. No. 61/337,649 filed Feb. 10, 2010.

### FIELD OF THE INVENTION

This invention addresses a cross layer optimization technique for TCP in which the need to send ACK frames across wireless links is contained by using the information from the MAC layer acknowledgements. More specifically the method significantly reduces bandwidth consumption and improves the performance of TCP on wireless networks. Furthermore, since the number of transmitted and received packets is reduced at the mobile device, the battery life of the device can be improved significantly. The proposed method can be applied to downlink and uplink ACK frames with a slight variation between the two.

### BACKGROUND OF THE INVENTION

The invention disclosed in this application uses any type modulation and more particularly is shown in the preferred embodiment using a method of modulation now known by its commercial designation, xMax. This new wireless physical layer technology developed by xG Technology Inc., referred to as xMAX, enables extremely low power Omni-directional transmissions to be received in a wide area. Using xMAX, significant bandwidth can be made available for supporting various wireless applications. Voice Over IP (VoIP) based cellular services are now being developed using xMAX. In xMAX-based cellular networks both the base station and the handsets will be equipped with an xMAX transceiver. A mobile device (xMAX handset) in such a network will be free to move in an area covered by multiple xMAX base stations. Although this cross layer optimization technique for TCP in which the need to send ACK frames across wireless links is contained by using the information from the MAC layer acknowledgements is disclosed in the preferred embodiment as being used in these types of integer cycle and pulse modulation systems it can be implemented on any broad band wireless technologies like WiMax, WiBro, Wi-Fi, 3GPP and HSDPA, or any other type of wired or wireless voice or data systems.

A heterogeneous MAC protocol proposed to support VoIP traffic in xMAX wireless networks has been discussed in previously filed patent applications U.S. Ser. Nos. 12/069,057; 12/070,815; 12/380,698; 12/384,546; 12/386,648; 12,387,811; 12/387,807; 12/456,758; 12/456,725; 12/460,497; 12/583,627; 12/583,644; 12/590,472; 12/590,469; 12/590,931; 12/653,021; 12/653,007; 12/657,324; 12/803,380; and, 12/804,058 which are incorporated by reference into this disclosure. In the heterogeneous MAC protocol described in these applications, guaranteed timeslots are assigned to forward VOIP packets, temporary timeslots are assigned to forward data packets and contention based access is used to exchange control messages. Note that this heterogeneous MAC protocol is used here as a reference protocol and similarly xMAX as a reference wireless network. The idea of a cross layer optimization technique for TCP in which the need to send ACK frames across wireless links is contained by using the information from the MAC layer acknowledgements as described herein can be used in other relevant systems.

TCP throughput issues on wireless links are well known and extensively researched. Due to wireless channel characteristics like fading, multipath and shadowing the packet error rate is higher on wireless links in comparison with wired links. Any segment that is lost in transit is interpreted by TCP as congestion on the network. The congestion control algorithm reduces the throughput of the TCP flow.

Most of the existing work related to TCP on wireless links is focused on improving the loss detection capabilities and adjusting the transmission and congestion window to reflect such loss of packets. Please refer to K. Brown and S. Singh, “M-TCP: TCP for Mobile Cellular Networks,” ACM Computer Communications Review (CCR), vol. 27, no. 5, 1997.

In the split-TCP approach the TCP session is split between the wired and wireless parts i.e. the TCP is terminated at the base station and a separate connection is established just between the base station and the mobile device. The TCP running at the base station buffers all incoming packets to the mobile device and falsely acknowledges them to the source. This allows the source to keep sending the packets without being influenced by the wireless part of the connection. Further details on split-TCP can be found in Swastik Kopparty, Srikanth V. Krishnamurthy, Michalis Faloutsos, Satish K. Tripathi Split TCP for Mobile Ad Hoc Networks, In Proceedings of the IEEE Global Communications Conference (GLOBECOM) 2002.

Some schemes focus on the problem of frequent disconnection between the base station and the mobile device. The time of such disconnect could cause the TCP source to timeout for want of an ACK and forces the source to perform a slow start that assumes congestion being the cause of ACK failures. Such a slow start scheme has a negative effect on the throughput of the TCP session. The approach to the disconnect problem that has been suggested is for the base station to keep sending an ACK for the last byte ACKed during the time of disconnection, thereby freezing the congestion and sending window at the source and avoiding throughput degradation.

The SNOOP protocol introduces a proxy stationed at the base station which listens to the TCP ACKs on the channel. The proxy also stores the packets that were transmitted by the base station. If the proxy detects a duplicate ACK it retransmits the packet stored in its buffer and thus the source is prevented from decrementing its congestion window. Please refer to E. Amir, H. Balakrishnan, S. Seshan, and R. Katz; Efficient TCP over Networks with Wireless Links; In Proceedings of 5th. Workshop on Hot Topics in Operating Systems, pages 35-41, May 1995 for details on SNOOP.

Park et. al. studied the issues of uplink ACK transmission in WiMAX networks. They proposed to assign bidirectional bandwidth for every downlink TCP segment. Downlink bandwidth assignment is for sending TCP segments to the mobile device. Uplink bandwidth assignment is for sending TCP ACK segments from the mobile device to the base station. For further details please refer to Eun-Chan Park, Chunyu Hu and Hwangnam Kim; Enhanced Bandwidth Allocation for TCP Flows in WiMAX Networks; Lecture Notes of the Institute for Computer Sciences, Social Informatics and Telecommunications Engineering; 1867-8211; Springer Berlin Heidelberg.

### BRIEF SUMMARY OF THE INVENTION

The invention disclosed in this application was developed for and is described in the preferred embodiment as being used in any integer cycle or impulse type modulation and more particularly a method of modulation known by its commercial designation, xMAX, but can be implemented on Wi-Fi, 3GPP, HSDPA or any other type of wired or wireless voice or data systems.

TCP is a full duplex transport layer protocol wherein both ends of a TCP connection can exchange data simultaneously. However, a significant number of TCP connections are unidirectional in nature. In unidirectional TCP flows, one end of the TCP connection sends TCP data segments while the other end sends only Acknowledgement (ACK) segments. For example, packets corresponding to http GET and POST commands and FTP sessions display this behavior. When a unidirectional TCP flow has to be sent over wireless networks a significant portion of the bandwidth is spent in sending ACK frames across the wireless links. This invention describes a cross layer optimization technique in which the need to send ACK frames across wireless links is contained by using the information from the MAC layer acknowledgements.

Therefore it is an object of this invention to have a method that significantly reduces bandwidth consumption and improves the performance of TCP on wireless networks. Furthermore, since the number of transmitted and received packets is reduced at the mobile device, the battery life of the device can be improved significantly. The proposed method can be applied to downlink and uplink ACK frames with slight variation between the two.

For a fuller understanding of the nature and objects of the invention, reference should be made to the following detailed description taken in connection with the accompanying drawings.

### DESCRIPTION OF THE DRAWINGS

For a fuller understanding of the nature and objects of the invention, reference should be made to the accompanying drawings, in which:

FIG. 1 is a diagram showing a TCP Header format;

FIG. 2 is a Histogram of TCP Segment Size (Y-axis in Logarithmic Scale);

FIG. 3 is a Histogram of TCP Segment Size;

FIG. 4 is a diagram showing Downlink unidirectional flow;

FIG. 5 is a diagram showing Uplink unidirectional flow; and,

FIG. 6 is a flowchart for TCP ACK Containment.

### DETAILED DESCRIPTION OF THE INVENTION

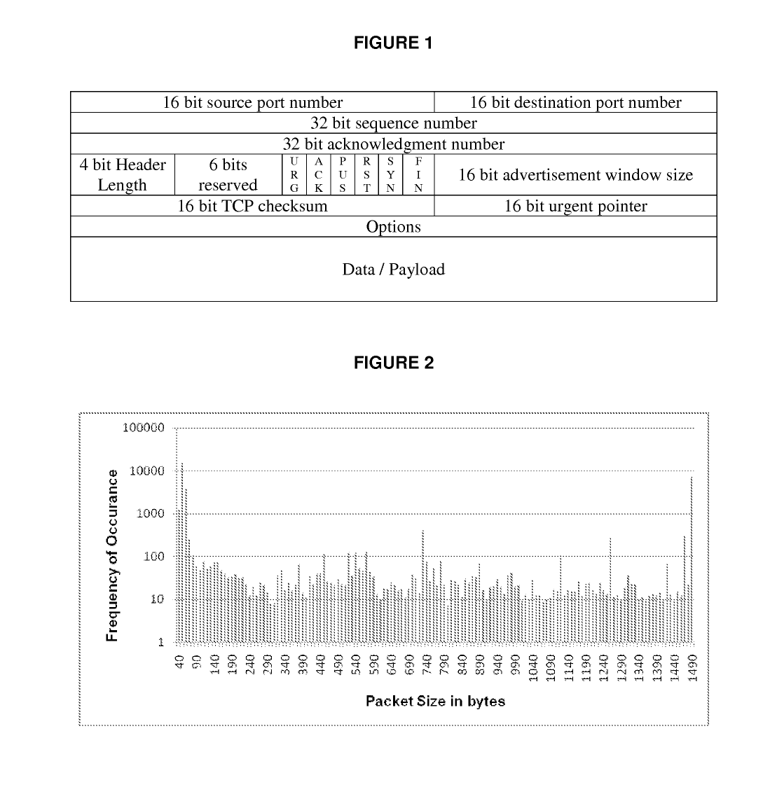

TCP is a transport layer protocol designed to support reliable, in-order, stream oriented, and connection-based full duplex communication between nodes across the Internet. To ensure reliability TCP uses cumulative Acknowledgements (ACKs) and retransmissions. A sequence number identifies every byte of data sent by TCP. The sender concludes that the receiver, only on receiving acknowledgement from the receiver, receives a chunk of data. The ACK number received should be greater than the corresponding sequence number. FIG. 1 shows the header information added to each TCP segment. For detailed information on the header please refer to RFC 793.

The Header of every TCP segment carries two 32 bit fields that correspond to the sequence number and the acknowledgement number. The sequence number field represents the sequence number of the first byte carried in the payload, or the data portion of the segment. The ACK field corresponds to the data sent from the other direction. It indicates the sequence number of the next byte expected from the other end of the TCP connection. Note that the ACK field in a TCP segment with payload is used only when both sides of the communication have data to send to each other concurrently. ACKs are piggy-backed with the data segments.

It is well known that TCP connections are predominantly unidirectional in nature; one side of the TCP flow sends data segments and the other side sends only ACK segments. Data flows associated with most of the Internet applications using TCP display this unidirectional characteristic. Examples of such application layer protocols include HTTP, FTP and Telnet.

To confirm the predominance of unidirectional TCP flows the following experiment was conducted. A PCAP (please refer to http://www.tcpdump.org/ for details on PCAP) based application was written to observe the packet sizes of all TCP segments sent and received from a desktop. The desktop was equipped with a Wi-Fi interface. The PCAP based application was recording the size of packets sent and received on this interface. The application was left running until 32,000 packets were observed by the application. During this time the user of the desktop was asked to conduct his normal tasks on the desktop. Some of these tasks like e-mail access, instant messaging and browsing websites involved accessing the Internet.

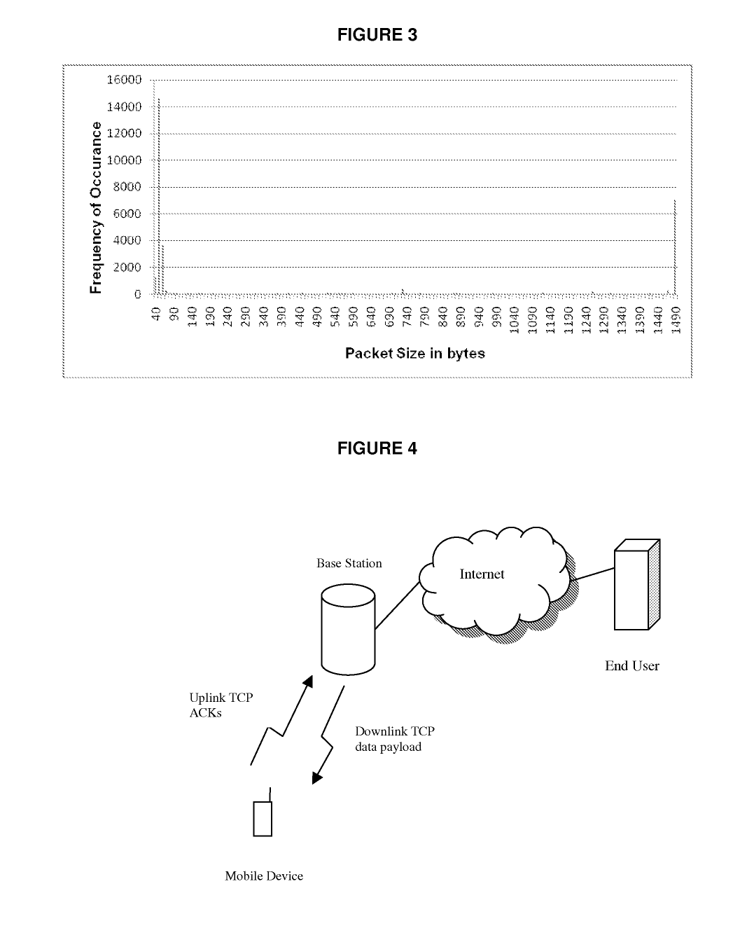

FIG. 2 shows the histogram of packet size distribution from this experiment. Note that the y-axis in this plot is in logarithmic scale. FIG. 3 depicts the same results on a linear scale y-axis. The packet sizes reported in these two plots includes 20 bytes of IP headers and 20 bytes of TCP headers. From FIG. 3 one can conclude that the collected data follows the typical bi-modal behavior of the internet traffic. There is one peak around 40-50 bytes and the second peak at 1490-1500 bytes. For more information on the bi-modal nature of Internet traffic please refer to Internet Packet Size Distribution: Some observation by Rishi Sinha, Christos Papadopoulos, John Heidemann, ISI-TR-2007-643, May 2007. Based on the fact that the collected data set reflects typical internet traffic packet size distribution one can conclude that the data set is generic enough to generalize the observations from this study.

From the results one can observe that about half of the packets are of a size less than 50 bytes. Further analysis leads one to the observation that all these packets are carrying TCP ACKs with no payload. The TCP ACK segments, which are longer than 40 bytes, had some optional TCP headers for timing. Based on these observations one can confirm that TCP flows are typically unidirectional in nature. When only one side of a TCP session sends data segments then the ACK field in corresponding header will not be populated. This information is conveyed to the other end by not setting the ACK bit. If the ACK bit is not set on any TCP segment then the receiver will ignore the content of the 32 bit ACK field.

In supporting unidirectional TCP flows a noticeable chunk of the bandwidth is consumed by the packets carrying ACKs segments. For example, if one has to send a 40 byte ACK segment for every 1500 byte data segment, and have a 1460 byte size payload and 40 bytes of header, then the overhead related to sending ACK frames is 2.67%. Note that if TCP segments carry a payload of less than 1460 bytes then the associated percentage of overhead will be higher. For example in the trace discussed above collected ACK segments accounted for about 7% of the total bytes sent. In wired networks this overhead might not be of any significance on the overall network performance. However, in wireless networks wherein the bandwidth is at a premium this overhead might not be justifiable. Also note that the PER in wireless networks is higher than the wired networks. As a result the ACK frame might have to be transmitted multiple times. The net overhead related to ACK frames will be higher in wireless networks.

In wireless networks the data flows are classified as downlink flows and uplink flows. A data flow from a base station to a mobile device is referred to as downlink flow. Similarly the data flow from a mobile device to a base station is referred to as uplink flow. In typical usage scenarios one will have more data fragments in the downlink than in the uplink. It is commonly agreed that the ratio of data sent in downlink and uplink is approximately 2:1. In unidirectional TCP downlink data flows there are data segments sent in downlink and ACK segments sent in uplink. For downlink transmissions the base station can decide the channel/timeslot assignment to mobile devices based on the packets that it received from the backhaul. However, for uplink ACK transmissions the mobile devices need to inform the base station that they need a channel for transmission. In almost all the systems such requests are sent using random access methodology. The latency involved in such methodologies is not deterministic. The mobile device needs to wait until a channel/timeslot is assigned by the base station and then schedule the transmission of the ACK frame. If the base station delays assigning a channel/timeslot to such nodes it will delay the ACK. Delay in sending ACK will increase the Round Trip Time (RTT) estimate at the source. The delay in assignment might be due to the random access delay or because of unavailability of the channel/timeslot. It is known that the TCP throughput when triple duplicate ACKs are used as loss indicators is approximated by the following equation:

$$B ( p ) = \frac{1}{RTT} \sqrt{\frac{3}{2 bp}}$$

### Where,

B(p)—throughput in terms of packets per second

p—loss probability

b—number of packets acknowledged by a received ACK (typically 2)

RTT—Round trip time

Please refer to J. Padhye, V. Firoiu, D. Towsley, J. Kurose. Modeling TCP Throughput: A Simple Model and its Empirical Validation; In Proceedings of SIGCOMM 98, for further details. Based on this equation one can conclude that increasing RTT decreases the throughput. In addition, uplink ACK segments have to compete with data segments of other TCP flows. As a result, the overall good-put of the system is reduced.

The invention of this disclosure helps to reduce, and in some cases totally eliminate, the TCP ACK packets sent across the wireless link. The current invention improves the system performance by conserving precious wireless channel resources that might have been used for sending TCP ACKs. Furthermore since the number of transmitted and received packets is reduced at the mobile device the battery life of the device can be improved significantly.

The details of the invention are now described by considering the uplink and downlink data flows. Uplink TCP ACK segments are triggered by the downlink transmission of TCP data segments. Please refer to the illustration shown in FIG. 4 where the mobile device is accessing a web page from a remote web server. In general, the maximum payload sent in a wireless frame is shorter than most of the TCP data segments. As a result, every packet arriving at the base station is divided into multiple fragments. Individual fragments are transmitted over the air-interface. If any of these fragments are lost they will be retransmitted. The mobile device sends link layer ACKs to allow the base station to detect lost fragments. On receiving the ACK for all the fragments the base station can implicitly conclude that the TCP data segment has successfully reached its destination.

The TCP ACK suppression invention of this disclosure is based on the above observation. The invention requires base stations to track session information of all active downlink TCP streams. On receiving the layer-2 ACKs for all the fragments the base station generates the TCP ACK fragment on behalf of the mobile device and sends it to the source of the TCP stream. The MAC layer at the mobile device will drop the corresponding TCP ACK fragment on receiving it from the transport layer instead of transmitting it over the air-interface.

The MAC layer ACKs and the TCP layer ACKs are two distinct messages conveying the same information (success or failure) about a particular packet. The base station, based on the MAC layer ACKs, already has the information of a successful packet transmission and the TCP ACKs do not provide any further information to the base station. Thus the invention proposes generating the TCP ACK at the base station after reception of MAC layer ACKs and eliminating the sending of TCP ACKs at the mobile device. This approach requires cross layer knowledge and thus the MAC layer at the mobile device should be able to detect a TCP ACK fragment so that it can be discarded. Similarly the MAC layer at the base station needs to frame a TCP ACK segment based on the MAC ACK received from the mobile device.

The mobile device MAC on receiving a packet from the higher layer checks the TCP header to see if the ACK flag is set which indicates the presence of a TCP ACK fragment. If there is no payload in this TCP fragment then it indicates that the current packet is an ACK only fragment and may be discarded. If the payload is not empty, the mobile device needs to transmit the packet and the base station on its end will check the existence of payload data. If the payload exists the base station will refrain from generating the ACK for the corresponding streams any longer and the packet goes through without any modifications.

The base station keeps track of all ongoing TCP sessions based on the source IP, destination IP, source port number, and destination port number. On establishment of a TCP session, the MAC layer at the base station starts tracking the session by recording the above fields for that mobile device. The MAC layer also assumes initially that the session is unidirectional. The MAC layer in the base station will generate the TCP ACK with the fields described above indicating the next byte expected and send it out to the source.

If a particular TCP flow is bidirectional then the mobile device will piggyback ACKs with payload TCP segments. Note that the TCP layer of the mobile device is unaware of the TCP ACK generated at the base station. By the time a piggybacked ACK packet is sent by the mobile device on the air-interface, the base station, based on the MAC ACKs, would have generated a TCP ACK and sent it out to the source. On reception of the actual TCP ACK packet, the base station MAC detects the presence of the ACK+payload and concludes that the flow is bidirectional. It also allows the packet with the ACK to go through to the source. Thus the source receives one duplicate TCP ACK. Note that the TCP protocol is designed not to react until the reception of three duplicate ACKs. Thus, receiving one duplicate ACK does not deteriorate the performance of TCP. On detecting data flow in both directions the MAC at base station stops generating TCP ACK packets based on the MAC layer ACKS.

Note that the bidirectional data flow in a TCP session might be intermittent. To adapt to the changing nature of the flow one treats the flow as unidirectional if ‘k’ successive TCP ACKs without payloads are sent by the mobile device and the base station will then revert back to generating TCP ACKs based on the MAC layer ACKs. The value of ‘k’ can either be predetermined or dynamically modified based on the flow characteristics.

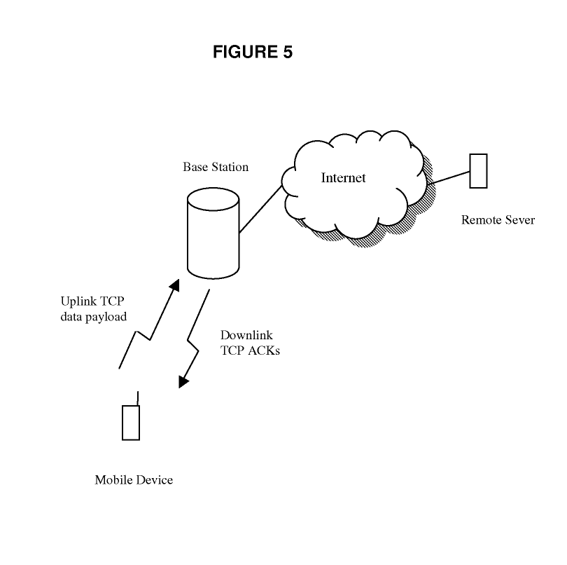

Referring now to FIG. 5, an illustration of uplink TCP flows is shown. Here, the mobile device is connected to a remote file server and is uploading a file. The TCP data segments are sent by the mobile device to the base station. The base station forwards the TCP segments to the server. On receiving these TCP segments the server generates TCP ACKs. Unlike downlink unidirectional flows we cannot use the link layer ACK received by the mobile device to determine a successful transmission. Note that successful transmission over the air-interface does not guarantee that the packet has reached its destination because the packet may be dropped by an intermediate router due to congestion in the network. As a result, a variation of the previous solution is used in this case.

As discussed above, successful link layer transmission of the Uplink TCP segment is not sufficient to guarantee end-to-end transmission success. The base station reassembles the link layer fragments and sends the packet to the remote server. If the packet arrives successfully the server generates an ACK segment. To transmit this TCP ACK segment the base station assigns downlink resources to the corresponding mobile device. Downlink resource assignment information is typically included in a broadcast channel. Instead of assigning the downlink resource and then transmitting the TCP ACK one should transmit a compressed form of TCP ACK in the broadcast channel. By sending limited ACK information in a broadcast control message one frees up system capacity. On receiving an ACK segment the base station extracts relevant information from the TCP header. This bare minimum information is then sent in the broadcast channel to the mobile device. If at some point the remote end point decides to send payload with ACK in a segment the base station reverts to the normal mode of operation and assigns dedicated downlink resources to the corresponding mobile device.

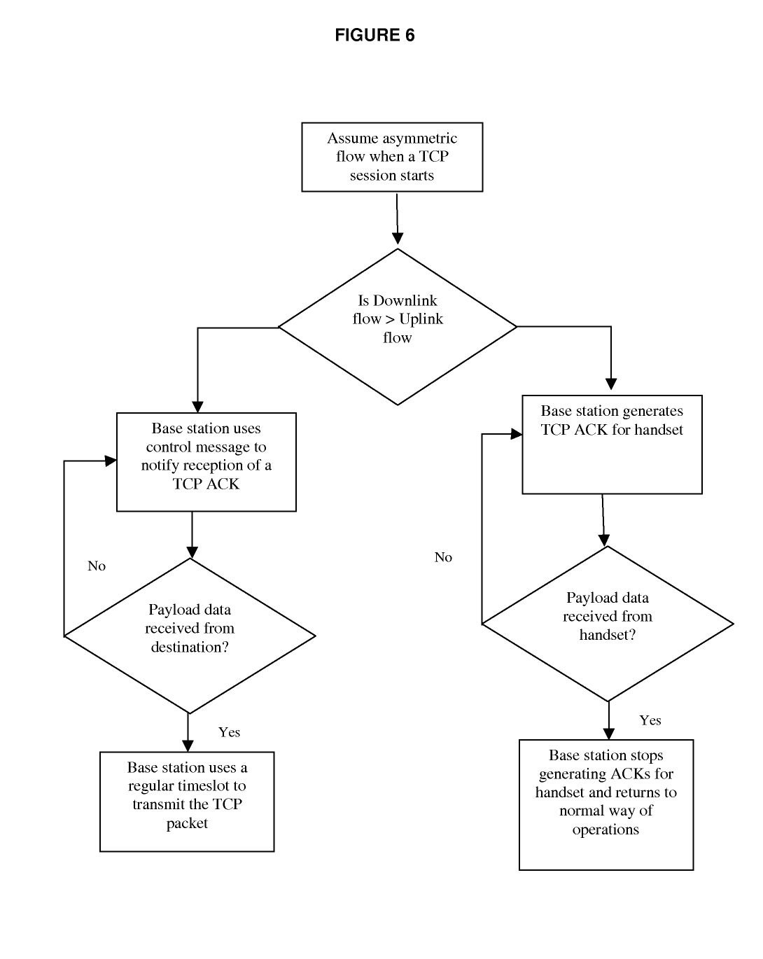

Since the flow is unidirectional in the uplink direction the mobile device always has the TCP payload to transmit. On receiving a TCP segment from higher layers the MAC layer stores a local copy of the TCP header. The mobile device listens to the broadcast channel in order to receive downlink resource assignments. If there is only ACK arriving from the remote server the base station will send limited TCP ACK information in the broadcast channel. The MAC then uses a combination of the locally stored TCP header and the limited ACK information to recreate the TCP ACK. The TCP layer on the mobile device is unaware of the entire process and receives an ACK segment as expected. The Flowchart for the TCP ACK containment is shown in FIG. 6.

As discussed above both the base station and the mobile device are expected to prepare a TCP ACK segment depending upon the direction of TCP flow. Only a few fields in the TCP header change during a session. This information must be available in real time to allow successful regeneration of TCP ACK. To understand which fields in the TCP header may change during a session please refer to FIG. 1 and the list below:
1. Port numbers (Source & Destination)—do not change during a session.
2. Sequence number—if no payload is present in ACK this field is not relevant.
3. Acknowledgement number—changes with every transmission hence must be updated for every segment.
4. Data offset—only relevant when optional fields are used.
5. Flags—if any of the flags are set this must be conveyed for correct ACK regeneration.
6. Receive window—needed for flow control and hence must be updated.
7. Checksum—can be generated locally.
8. Options fields—these are used in rare cases and must be handled correctly.
   Thus, during a normal TCP flow, only the Acknowledgement number and window size changes regularly. In the case of Uplink ACK suppression the base station must extract these two fields and send them in the broadcast channel.

The current invention describes a novel mechanism to improve TCP throughput by efficient utilization of link bandwidth. Various traffic studies clearly depict the unidirectional nature of uplink and downlink TCP flows. Other proposals suggest mechanisms to allocate dedicated bidirectional bandwidth to handle the TCP ACKs generated in these unidirectional flows. The method of this disclosure allows suppression (complete elimination in some scenarios) of the ACK packets. Thus the disclosed method avoids any resource allocation for sending TCP ACK segments. The unallocated resources can then be used to supplement other TCP flows leading to a significant increase in system throughput. Note that in wireless/mobile environments packet loss is frequent. By suppressing ACK packets the probability of packet loss is decreased as ACK segments are no longer transmitted over the wireless media.

Since certain changes may be made in the above described method of a cross layer optimization technique for TCP in which the need to send ACK frames across wireless links is contained by using the information from the MAC layer acknowledgements without departing from the scope of the invention herein involved, it is intended that all matter contained in the description thereof or shown in the accompanying figures shall be interpreted as illustrative and not in a limiting sense.

What is claimed is:

1. A method to reduce bandwidth usage between a base station and a mobile device on a wireless system having both TCP and MAC protocols by not sending some TCP acknowledgment messages between the base station and the mobile device comprising:
said base station tracking TCP session information regarding source IP, destination IP, source port number, and destination port number and then for fragmented downlink TCP message streams from a source generating a TCP acknowledgment message from said TCP session information to send back to a source after receiving all MAC layer acknowledgment messages from said mobile device and said mobile device detecting and not sending fragmented uplink TCP acknowledgment messages that do not contain payload data to said base station and if a certain amount of TCP acknowledgment messages containing payload data sent from said mobile device are detected said base station stops generating said TCP acknowledgment message; and,
for fragmented uplink TCP message streams sent from a mobile device through said base station and to a source said base station compressing any TCP acknowledgement message that contains no payload data received back from a source and transmitting said compressed TCP acknowledgment message back to said mobile device using a broadcast channel and transmitting any said uncompressed TCP acknowledgment message containing payload data received back from a source through a MAC timeslot.
